(19) United States
(12) Patent Application Publication
(10) Pub. No.: US 2008/0086465 A1
(43) Pub. Date: Apr. 10, 2008

(54) ESTABLISHING DOCUMENT RELEVANCE BY SEMANTIC NETWORK DENSITY

(76) Inventors: Nathan D. Fontenot, Cedar Park, TX (US); Jacob Lorien Moilanen, Austin, TX (US); Joel Howard Schoop, Austin, TX (US); Michael Thomas Strosaker, Austin, TX (US)

Correspondence Address: IBM CORP (YA);C/O YEE & ASSOCIATES PC, P.O. BOX 802333, DALLAS, TX, 75380, US

(21) Appl. No.: 11/539,753

(22) Filed: Oct. 9, 2006

(51) Int. Cl. G06F 17/30

(52) U.S. Cl. 707/5

(57) ABSTRACT

A computer implemented method, data processing system, and computer program product for establishing document relevance by semantic network density. When a search query is received, one or more semantic networks are identified which contain nodes matching one or more terms in the search query. An edge density is determined for each node matching a term in the search query. A relevancy score is then calculated for each of the one or more semantic networks based on the edge densities of the nodes matching a term in the search query. Based on the relevancy score, the relevancy to the search query of a document associated with the one or more semantic networks may then be determined.

### BACKGROUND OF THE INVENTION

1. Field of the Invention

The present invention relates generally to an improved data processing system, and in particular, to a computer implemented method, data processing system, and computer program product for establishing document relevance by semantic network density.

2. Description of the Related Art

The Internet is a globally accessible network of computers that collectively provide a large amount and variety of information to users. From services of the Internet such as the World Wide Web (or simply, the “Web”), users may retrieve or “download” data from Internet network sites and display the data that includes information presented as text in various fonts, graphics, images, and the like having an appearance intended by the publisher. As the information revolution has exploded, more and more information is available through the Internet. However, finding particular pieces of information out of the millions of “Web sites” available can be daunting.

One way of sorting through this mass of information to find what is of interest for a particular user is through the use of “search engines”. Search engines are software written to search, among the millions of web sites or large document repositories, for certain key words or search criteria entered by a user, and to return to the user a list of links (such as references to other HTML pages) to the sites or documents that the search engine determines to be most relevant to the criteria entered by the user. Different search engines use different methods of determining the relevance of the web sites or documents, but most use some sort of quantitative method that determines the relevance of a site or document based on how many times the search words entered by the user appear within that particular site or document.

Search engines typically return only a list of links of sites or documents which contain one or more references to the search terms entered by the user. Often times, this list does not necessarily contain sites or documents that are actually relevant to a search query. A user may have difficulty in finding a site or document that is actually relevant to the search query since existing search engines classify Web pages and documents based on raw statistical analysis of the words in a page. This raw statistical analysis technique is often called the “bag of words” model. Using the “bag of words” model, existing search engines do not take into consideration the meaning of the words, or the significance of the relationships between concepts. While such existing search models are adequate for merely locating Web sites or documents which contain one or more terms in a user's search query, these search models lack the ability to determine which of the documents located is most relevant to the search query.

### SUMMARY OF THE INVENTION

The illustrative embodiments provide a computer implemented method, data processing system, and computer program product for establishing document relevance by semantic network density. When a search query is received, one or more semantic networks are identified which contain nodes matching one or more terms in the search query. An edge density is determined for each node matching a term in the search query. A relevancy score is then calculated for each of the one or more semantic networks based on the edge densities of the nodes matching a term in the search query. Based on the relevancy score, the relevancy to the search query of a document associated with the one or more semantic networks may then be determined.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the illustrative embodiments may be implemented;

FIG. 2 is a block diagram of a data processing system in which the illustrative embodiments may be implemented;

FIG. 3 is a block diagram of exemplary components with which the illustrative embodiments may be implemented;

FIG. 4A is an example semantic network for a document in accordance with the illustrative embodiments;

FIG. 4B is an example semantic network for a document in accordance with the illustrative embodiments; and

FIG. 5 is a flowchart of a process for establishing document relevance by semantic network density in accordance with the illustrative embodiments.

### DETAILED DESCRIPTION OF THE PREFERRED EMBODIMENT

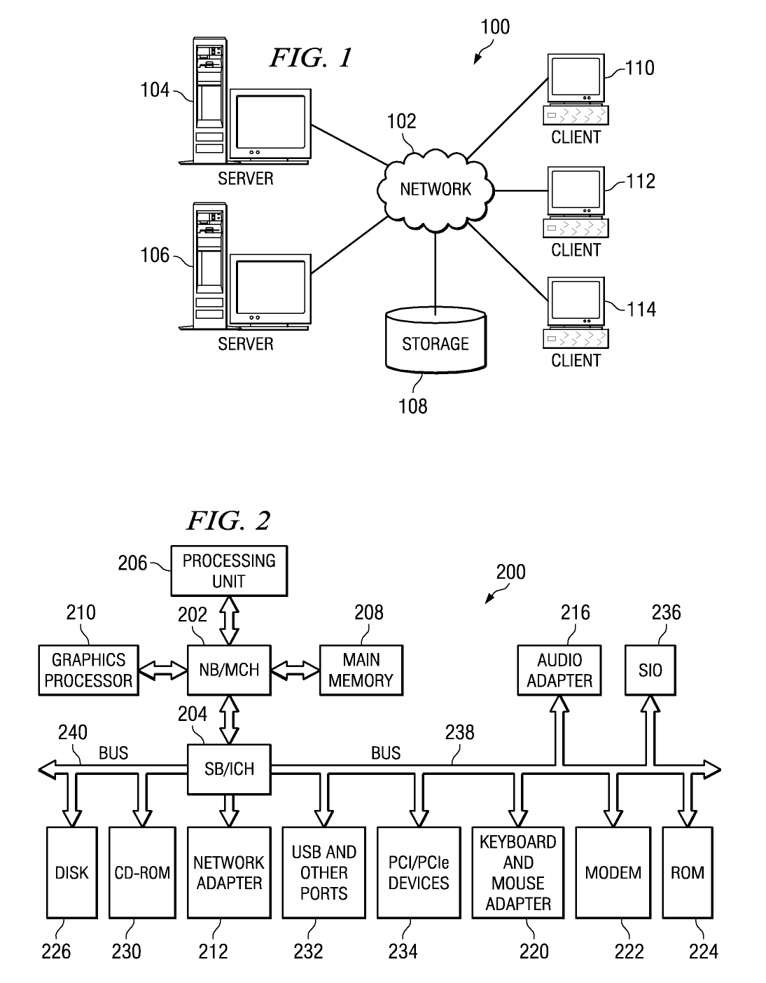

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

As previously mentioned, there are several known traditional search algorithms in the existing art which return, based on search terms entered by a user, a list of documents which contain one or more references to the search terms in the user's query. One of these traditional search algorithms is the “bag of words” model, which classifies documents based on a raw statistical analysis of the number of search terms in the page. While these traditional search algorithms may return a list of matching documents which contain one or more of the search terms in the query, these traditional algorithms do not necessarily allow for locating a document that is actually relevant to the search, for they do not take into consideration the meaning of the words or the relationships between them. The illustrative embodiments address this issue by providing a relevancy algorithm for determining how relevant a matching document is to the terms in the search query. A list of matching documents (i.e., documents containing one or more of the search terms) may be obtained using any of the traditional search algorithms in the art. Once the list of documents that contain a match to one or more search terms in the query is obtained, the relevancy algorithm described in the illustrative embodiments may be used to determine the relevancy of the matching documents to the search terms.

Prior to receiving a search query, a repository of documents is indexed for search. During the indexing, one or more semantic networks are generated for each document in the repository. Any known method of generating semantic networks may be used to implement the illustrative embodiments. A semantic network is a diagram that represents concepts that are specified in the document, as well as the relationships between the concepts. A concept may be an idea or thought that has meaning. The semantic network comprises nodes which represent the concepts, and edges which represent the semantic relations between the concepts. The generated semantic networks may be stored with the index in the repository.

The relevancy algorithm for scoring each matching document may include a search of all of the semantic networks in the repository to locate those networks which have one or more terms which match the terms in the search query. When a search query is received from a user, the relevancy algorithm first searches the semantic networks for documents containing terms which match the terms in the search query. This search for matching networks may also be performed using traditional algorithms, such as “bag of words” matching and enumeration of referring documents. Regardless of the manner of obtaining a list of document which contain terms matching the search query, the relevancy algorithm is then used to rank those matching documents according to each document's relevancy to the search terms. The relevancy algorithm ranks the matching networks for the documents in the list by first determining which of the semantic networks have a higher edge density around the nodes which correspond to the search terms. The edge density for a node is simply the number of edges (i.e., relationship connections) incident to the relevant node (i.e., concept). The relevancy algorithm scores each matching semantic network based on the total number of edges in the network multiplied by the total number of matching terms in the network. If a document contains multiple matching semantic networks, the scores for each or the matching semantic networks are added together. Semantic networks having a higher edge density score are ranked as being a better match to the search query. Thus, documents that have a significant amount of context around the term(s) of interest are more likely to be relevant to the query.

The relevancy algorithm described in the illustrative embodiments provides an improvement over traditional search algorithms which determine the relevancy of a document only by the quantity of the search terms in the document and/or number of referring documents. The relevancy algorithm technique also overcomes the storage problems typically associated with semantic networks. A disadvantage of using semantic networks is the exorbitant storage requirements for storing an entire semantic network, as opposed to traditional search algorithms such as the “bag of words” model which only require one to store a list of keywords, as well as possibly storing the number of occurrences of each keyword. However, the relevancy algorithm technique in the illustrative embodiments mitigates the semantic network storage requirement by only storing the list of keywords and the number of edges incident to each keyword. For instance, when the documents are indexed as described above, the list of keywords along with the number of incident edges for each keyword are stored, rather than the entirety of the semantic network. Thus, the amount of additional storage required to implement the relevancy algorithm technique is only negligibly greater (if at all) than the storage requirements of traditional search algorithms.

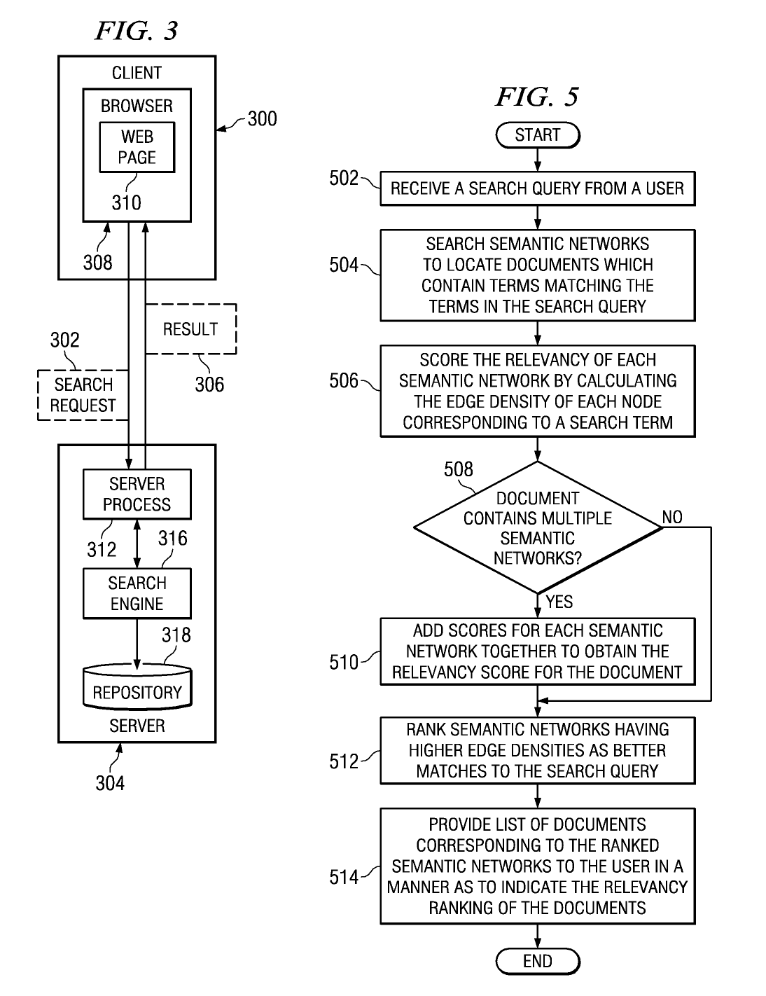

Turning next to FIG. 3, a diagram illustrating components used in generating and performing a search is depicted in accordance with the illustrative embodiments of the present invention. In this example, client 300 sends search request 302 to server 304 and receives result 306. Client 300 or server 304 may be implemented using data processing system 200 in FIG. 2.

In this particular Web-based search example, browser 308 is an application executing on client 300. Web page 310 is currently displayed in browser 308. When the user enters search criteria into Web page 310, the search criteria is sent in search request 302, which is received by server process 312 in server 304.

Server process 312 processes search request 302 and sends the search terms to search engine 316, which performs a search using repository 318 to identify sources of information related to the search terms. Repository 318 contains an index used to search documents stored within. This index also contains mappings to different Web pages or other types of content that may be searched based on the search terms. These mappings may be static or may change over time. Search engine 316 may be implemented using various well-known search engines. Some search engines which may be used include, for example, AltaVista, Google, and HotBot. Depending on the particular implementation, search engine 316 may be located on a different data processing system than server process 312.

Search engine 316 generates semantic networks for repository 318. A document or Web page may contain one or more semantic networks. The semantic networks may be stored with the index in repository 318. In one example, all of the terms in the semantic networks may be stored within a symbol table to allow the search engine to easily locate the nodes corresponding to the search terms.

The results of the search query are sent to server process 312 for return to client 300 in result 306. Result 306 may be, for example, a particular Web page containing the information related to the search terms or a Web page containing links to Web pages satisfying the search criteria.

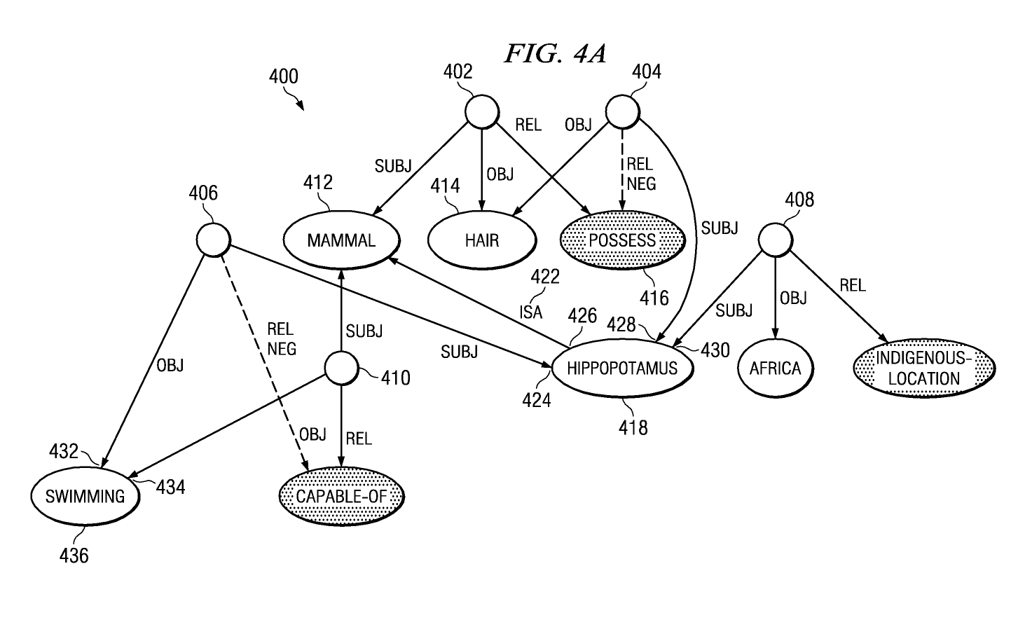

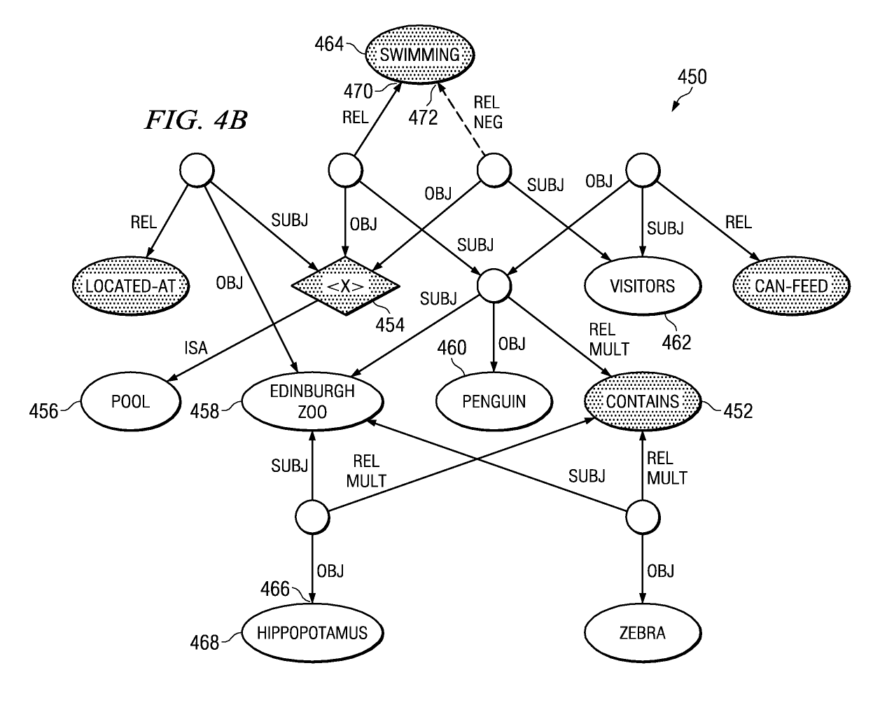

FIGS. 4A and 4B are example semantic networks for different documents in accordance with the illustrative embodiments. Consider the simple example of a user who enters the search query, “Can a hippopotamus swim?”, into a Web search engine. In this particular example, two documents are identified by the Web search engine as containing one or more terms in the search query. The text of the first matching document reads:
The hippopotamus, a creature indigenous to parts of Africa, is the only mammal that cannot swim. It is also the only mammal that does not have hair.
   The text of the second matching document reads:
There are a number of animals in the Edinburgh zoo, including penguins, zebras, and hippopotamuses. Visitors can feed the penguins, but they cannot swim in the penguin pool.

As shown, semantic network 400 in FIG. 4A for the first matching document contains one occurrence each of the word “hippopotamus” and the word “swim”. Likewise, semantic network 450 in FIG. 4B for the second matching document also contains one occurrence each of the word “hippopotamus” and the word “swim”. As previously mentioned, the search engine may identify those semantic networks which contain matching terms by using a traditional search algorithm. However, using traditional search algorithms, the search engine would rank the documents as equally relevant to the search query, since both documents each contain one instance of the word “hippopotamus” and of the word “swim”. The documents may also have similar number of references to each page by a page ranking algorithm, such as Google's.

In contrast, with the relevancy algorithm, the semantic networks of the two documents are further analyzed to identify which documents are more relevant to the content of the search query. The search engine may rank the relevancy of the documents based on the number of edges around the concepts (i.e., terms) in the search query. For example, semantic network 400 in FIG. 4A comprises the text of the first matching document. The dots, such as dots 402, 404, 406, 408, and 410, are used to indicate propositions, which are simple sentences. Dots 402-410 have pointers which connect subjects, relations, and objects. For instance, dot 402 indicates a proposition containing a subject (“mammal” 412), an object (“hair” 414), and the relation (“possess” 416) between mammal 412 and hair 414. Likewise, dot 404 indicates a proposition containing subject “hippopotamus” 418, object “hair” 414, and relation possess 416.

A relation may also be negative, such that the meaning of the relation is inverted. For example, the negative relation illustrated by dotted line 420 indicates that the text of the document specifies that a hippopotamus does not possess hair. “Is a” 422, or “is a”, is commonly used in semantic networks to define hierarchies. For example, if nodes “rodent”, “mouse”, “animal”, and “mammal” are in a semantic network, “is a” may be used to specify the hierarchy between the nodes, such as “a mouse is a rodent is a mammal is a animal”. From the specified hierarchy, it may be understood that all the properties of a mammal apply to a mouse (i.e., possesses hair, gives birth to young live, etc.). In this particular case in FIG. 4A, “is a” 422 specifies that that “a hippopotamus is a mammal”.

The relevancy algorithm analyzes semantic network 400 to determine how many edges there are around the concepts specified in the search query. With the search query, “Can a hippopotamus swim?”, semantic network 400 is shown to contain an edge density of four edges 424, 426, 428, and 430 around the concept of hippopotamus 418, and an edge density of two edges 432 and 434 around the concept of swimming 436. Once the number of edges for each concept specified in the search query is known, the relevancy algorithm obtains a total relevancy score for the semantic network by adding the number of edges together to obtain a total number of edges, and then multiplying the total number of edges by the number of terms in the network. In this example, the total relevancy score for semantic network 402 is twelve (e.g., 6 total edges*2 terms=12). Thus, the more edges (connections) a term has to other nodes in the network, the more relevant the document is likely to be to the user's search query.

Semantic network 450 in FIG. 4B comprises the text of the second matching document. As shown in FIG. 4B, some relations, such as relation “contains” 452, may have multiple relationships with concepts in the semantic network. In addition, “<x>” node 454 indicates that it is a specific instance of a concept. In this illustrative example, “<x>” node 454 indicates that there is a specific pool 456 at Edinburgh Zoo 458 in which there are penguins 460 and in which visitors 462 cannot swim 464. There may be another instance of a pool at another zoo in which there are dolphins and in which people can swim, for example, and which might be noted as “<y>” or something similar.

Although semantic network 450 is more complex than semantic network 402 in FIG. 4A, using the search query, “Can a hippopotamus swim?”, semantic network 450 is shown to contain an edge density of only one edge 466 around the concept of hippopotamus 468, and an edge density of only two edges 470 and 472 around the concept of swimming 464. Thus, for semantic network 450, the relevancy algorithm obtains a total relevancy score of six (e.g., 3 edges*2 terms=6). In this manner, the relevancy algorithm would rank the first matching document as a better match to the user's search query.

It should be noted that in the examples above, the search query, “Can a hippopotamus swim?”, is actually answered in semantic network 402 of the first matching document. In response to such a question, a deductive reasoning algorithm may be used to provide an actual “yes” or “no” answer. However, the deductive reasoning on a semantic network required by such an algorithm is much more computationally intensive than the relevancy algorithm in the illustrative embodiments. Additionally, the relevancy algorithm may still be useful with more generic search strings. For example, instead of a search comprising a question such as “Can a hippopotamus swim?”, a generic search query may merely comprise the terms, “hippopotamus swim”. In this generic search string situation, the relevancy algorithm would be able to determine the relevancy of a document to the search terms provided, while the deductive reasoning algorithm would have nothing to deduce.

FIG. 5 is a flowchart of a process for establishing document relevance by semantic network density in accordance with the illustrative embodiments. The process begins with receiving a search query from a user (step 502). When the search query is received, the relevancy algorithm first searches the semantic networks in a repository to locate documents which contain one or more terms which match the terms in the search query (step 504). Upon obtaining the semantic networks for the list of documents which match one or more terms in the search query, the relevancy algorithm scores the relevancy of each semantic network to the search query by calculating the edge density of each node corresponding to a search term (step 506). The relevancy algorithm may calculate a total relevancy score for each semantic network based on the total number of edges (i.e., relationship connections) incident to the relevant nodes (i.e., concepts) multiplied by the number of matching terms in the network. In other words, semantic networks that have a significant amount of context around the terms specified in the search query are more likely to be relevant to the query.

A determination is then made as to whether any of the documents in the list contains multiple semantic networks (step 508). If a document does not contain more than one semantic network (‘no’ output to step 508), the process skips to step 512. If a document contains more than one semantic network (‘yes’ output to step 508), the scores for each of the semantic networks are added together to form the relevancy score for the document (step 510). The semantic networks having a higher edge density are ranked as better matches to the search query (step 512). The list of documents corresponding to the ranked semantic networks are then be provided to the user in such a manner as to indicate the relevancy ranking (step 514), with the process terminating thereafter.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for establishing document relevance by semantic network density, the computer implemented method comprising:
responsive to receiving a search query, identifying one or more semantic networks containing nodes matching one or more terms in the search query;
determining an edge density for each node matching a term in the search query;
calculating a relevancy score for each of the one or more semantic networks based on the edge densities of the nodes matching a term in the search query; and
determining a relevancy, to the search query, of a document associated with the one or more semantic networks based on the relevancy score.

2. The computer implemented method of claim 1, wherein calculating a relevancy score for a semantic network further comprises:
determining a total number of nodes in the semantic network which match a term in the search query;
determining a total number of edges for all of the nodes in the semantic network which match a term in the search query; and
multiplying the total number of nodes by the total number of edges to obtain the relevancy score for the semantic network.

3. The computer implemented method of claim 2, further comprising:
responsive to a determination that a document is associated with one or more semantic networks, adding the relevancy scores of each of the semantic networks together to determine the relevancy of the document.

4. The computer implemented method of claim 1, wherein a semantic network having a higher edge density is more relevant to the search query.

5. The computer implemented method of claim 1, further comprising:
prior to receiving the search query, indexing a repository of documents to form an index; and
generating one or more semantic networks for each document in the repository.

6. The computer implemented method of claim 5, wherein terms in the one or more semantic networks are stored within a symbol table in the repository.

7. The computer implemented method of claim 1, wherein the edge density for a node is a number of edges incident to the node.

8. The computer implemented method of claim 1, wherein the semantic network consists only of a list of nodes and a number of edges incident to each node.

9. A data processing system for establishing document relevance by semantic network density, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to identify one or more semantic networks containing nodes matching one or more terms in a search query in response to receiving the search query, determine an edge density for each node matching a term in the search query, calculate a relevancy score for each of the one or more semantic networks based on the edge densities of the nodes matching a term in the search query, and determine a relevancy, to the search query, of a document associated with the one or more semantic networks based on the relevancy score.

10. The data processing system of claim 9, wherein the processing unit further executes the computer usable code to calculate a relevancy score for a semantic network by determining a total number of nodes in the semantic network which match a term in the search query, determining a total number of edges for all of the nodes in the semantic network which match a term in the search query, and multiplying the total number of nodes by the total number of edges to obtain the relevancy score for the semantic network.

11. The data processing system of claim 10, wherein the processing unit further executes the computer usable code to add the relevancy scores of each of the semantic networks together to determine the relevancy of a document in response to a determination that the document is associated with one or more semantic networks.

12. The data processing system of claim 9, wherein a semantic network having a higher edge density is more relevant to the search query.

13. The data processing system of claim 9, wherein the processing unit further executes the computer usable code to index a repository of documents to form an index prior to receiving the search query, and generate one or more semantic networks for each document in the repository.

14. A computer program product for establishing document relevance by semantic network density, the computer program product comprising:
a computer usable medium having computer usable program code tangibly embodied thereon, the computer usable program code comprising:
computer usable program code for identifying one or more semantic networks containing nodes matching one or more terms in a search query in response to receiving the search query;
computer usable program code for determining an edge density for each node matching a term in the search query;
computer usable program code for calculating a relevancy score for each of the one or more semantic networks based on the edge densities of the nodes matching a term in the search query; and
computer usable program code for determining a relevancy, to the search query, of a document associated with the one or more semantic networks based on the relevancy score.

15. The computer program product of claim 14, wherein the computer usable program code for calculating a relevancy score for a semantic network further comprises:
computer usable program code for determining a total number of nodes in the semantic network which match a term in the search query;
computer usable program code for determining a total number of edges for all of the nodes in the semantic network which match a term in the search query; and
computer usable program code for multiplying the total number of nodes by the total number of edges to obtain the relevancy score for the semantic network.

16. The computer program product of claim 15, further comprising:
computer usable program code for adding the relevancy scores of each of the semantic networks together to determine the relevancy of a document in response to a determination that the document is associated with one or more semantic networks.

17. The computer program product of claim 14, wherein a semantic network having a higher edge density is more relevant to the search query.

18. The computer program product of claim 14, further comprising:
computer usable program code for indexing a repository of documents to form an index prior to receiving the search query;
computer usable program code for generating one or more semantic networks for each document in the repository.

19. The computer program product of claim 14, wherein the semantic network consists only of a list of nodes and a number of edges incident to each node.

20. The computer program product of claim 14, wherein the edge density for a node is a number of edges incident to the node.
